(19) United States
(12) Patent Application Publication
(10) Pub. No.: US 2026/0347632 A1
(43) Pub. Date: Nov. 5, 2026

(54) ACTINIC RADIATION-CURABLE INKJET INK AND METHOD FOR PRODUCING PRINTED MATERIAL USING THE SAME

(71) Applicant: Konica Minolta, Inc., Tokyo (JP)

(72) Inventor: Hidekazu KAWASAKI, Tokyo (JP)

(21) Appl. No.: 19/639,427

(22) Filed: Apr. 6, 2026

(30) Foreign Application Priority Data
Apr. 11, 2025 (JP) 2025-065677

(51) Int. Cl. C09D 11/38; B41J 11/00

(52) U.S. Cl. CPC C09D 11/38; B41J 11/0021

(57) ABSTRACT

To provide an actinic radiation-curable inkjet ink that hardly causes satellite and mist in printing and can form a coating film having excellent glossiness. In order to achieve the above object, an actinic radiation-curable inkjet ink contains a photopolymerizable compound, a photoinitiator, a gelling agent, a pigment, and a pigment-dispersing agent. In addition, the actinic radiation-curable inkjet ink further contains a compound represented by a specific structural formula, and the amount of the photopolymerizable compound is 70% by mass or more based on the total mass of the actinic radiation-curable inkjet ink.

### CROSS REFERENCE TO RELATED APPLICATIONS

Japanese Patent Application No. 2025-065677 filed on Apr. 11, 2025, including description, claims, and abstract the entire disclosure is incorporated herein by reference in its entirety.

### BACKGROUND

### Technological Field

The present invention relates to an actinic radiation-curable inkjet ink and a method for producing a printed material using the same.

### Description of Related Art

Image formation by an inkjet method is used in various printing fields because an image can be formed easily and inexpensively. One of the image forming methods is a method in which droplets of an actinic radiation-curable inkjet ink are landed on a recording medium and then cured by irradiation with actinic radiation. According to the method, it is possible to form an image even on a recording medium having no ink absorbency. An actinic radiation-curable inkjet ink generally contains a photopolymerizable compound, a polymerization initiator, and a color material such as pigment (e.g., Japanese Unexamined Patent Publication No. 2014-156506).

When ink droplets are discharged from an inkjet nozzle of an inkjet apparatus, pressure is applied to the ink droplets or the ink droplets are electrically charged. As a result, some of ink droplets break apart, causing phenomena called satellites and mist. A satellite refers to an unintended ink droplet that has divided from a main droplet of ink, and a printing failure occurs when the satellite lands on a recording medium. In addition, mist refers to ink droplets having a significantly smaller diameter than satellites, and the mist leads to contamination of inkjet nozzles and surrounding devices.

In order to reduce the satellites and the mist, attempts have been made to lower the viscosity of the ink and to reduce the surface tension of the ink. However, in such an adjustment method, an inkjet ink is less likely to be formed into droplets, which causes a problem that printing becomes difficult or an image having a desired quality is less likely to be obtained. Another problem is that it is difficult to obtain a high-gloss image with conventional ink. The reason for this is not certain, but it is thought that one of the causes is that the surface of the ink droplets is normally easily negatively charged, and the charges on the surface of the ink droplets repel the charges on the surface of the recording medium (for example, a resin recording medium), or the ink droplets repel each other, and thus the surface of the image becomes uneven.

### SUMMARY

The present invention has been made in view of the above-mentioned circumstances. An object of an aspect of the present invention is to provide an actinic radiation-curable inkjet ink that is less likely to cause satellites and mist during printing and can form a coating film having excellent glossiness, and a method for producing a printed material using the actinic radiation-curable inkjet ink.

An aspect of the present invention for achieving the above-described object provides an actinic radiation-curable inkjet ink, comprising:
a photopolymerizable compound, a photoinitiator, a pigment, and a pigment-dispersing agent, wherein
the actinic radiation-curable inkjet ink further comprises a compound represented by General formula (1) below:

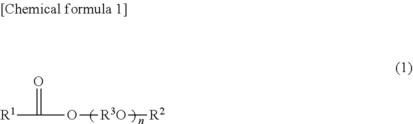

in General formula (1),
R¹ represents a substituted or unsubstituted alkyl group, a substituted or unsubstituted alkenyl group, a substituted or unsubstituted alkoxy group, a substituted or unsubstituted alkylthio group, a substituted or unsubstituted aryl group, a substituted or unsubstituted heterocyclic group, or a combination thereof,
R² represents a hydrogen atom, a substituted or unsubstituted alkyl group, a substituted or unsubstituted alkenyl group, a substituted or unsubstituted alkynyl group, a substituted or unsubstituted aryl group, a substituted or unsubstituted heterocyclic group, or a combination thereof,
R³ represents a substituted or unsubstituted alkylene group having 2 or more and 6 or less carbon atoms, and
n represents an integer of 1 or more and 50 or less, and
an amount of the photopolymerizable compound is 70% by mass or more based on a total mass of the actinic radiation-curable inkjet ink.

In addition, an aspect of the present invention for achieving the above-described object provides a method for producing a printed material, the method comprising:
discharging an ink droplet of the actinic radiation-curable inkjet ink from an inkjet recording head to cause the ink droplet to land on a recording medium; and
irradiating the ink droplet having landed on the recording medium with actinic radiation to cure the ink droplet.

### DETAILED DESCRIPTION OF EMBODIMENTS

Hereinafter, an embodiment of the present invention will be described in detail. However, the present invention is not limited to the following embodiment.

### 1. Actinic Radiation-Curable Inkjet Ink

The actinic radiation-curable inkjet ink of the present embodiment contains a photopolymerizable compound, a photoinitiator, a pigment, a pigment-dispersing agent, and a compound represented by General formula (1) described below. In the present specification, the “actinic radiation-curable inkjet ink” (hereinafter, also referred to as “ink”) means an ink curable by actinic radiation. In addition, the “actinic radiation” means radiation capable of curing the ink by activating the photoinitiator in the ink. Examples of the actinic radiation include α-ray, γ-ray, X-ray, ultraviolet ray, visible light, electron beam and the like. Note that the actinic radiation for curing the ink of the present embodiment is preferably an ultraviolet ray, visible light, and an electron beam, and more preferably an ultraviolet ray or visible light, from the viewpoint of availability of an irradiation device, curability of the ink, and the like.

As described above, a conventional ink has a problem of being easily divided to form satellites and mist when extruded from an inkjet head. Furthermore, there has also been a problem that printed material obtained from conventional inks have low glossiness. In contrast, since the ink of the present invention contains a compound represented by the following General formula (1) (hereinafter, also referred to as a “droplet adjusting agent”), satellites and mist are less likely to be generated, and furthermore, the obtained image has excellent glossiness.

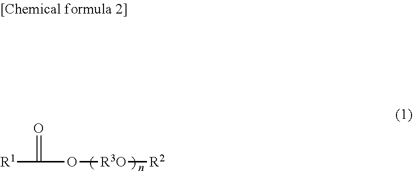

(In General formula (1), R¹ represents a substituted or unsubstituted alkyl group, a substituted or unsubstituted alkenyl group, a substituted or unsubstituted alkoxy group, a substituted or unsubstituted alkylthio group, a substituted or unsubstituted aryl group, a substituted or unsubstituted heterocyclic group, or a combination thereof, R² represents a hydrogen atom, a substituted or unsubstituted alkyl group, a substituted or unsubstituted alkenyl group, a substituted or unsubstituted alkynyl group, a substituted or unsubstituted aryl group, a substituted or unsubstituted heterocyclic group, or a combination thereof, R³ represents a substituted or unsubstituted alkylene group having 2 or more and 6 or less carbon atoms, and n represents an integer of 1 or more and 50 or less).

The reason why the above-described effect is obtained by the addition of the droplet adjusting agent is not clear, but it is considered as follows. The droplet adjusting agent described above has a portion having relatively high hydrophobicity (hereinafter, also referred to as a “hydrophobic portion”) represented by R¹C(═O) in General formula (1) and a portion having high hydrophilicity (hereinafter, also referred to as a “hydrophilic portion”) adjacent thereto. Next, when the ink of the present embodiment is extruded from an inkjet head, the hydrophobic portions of the droplet adjusting agent tend to move to the surface (gas-liquid interface) side of the droplet and align, and the droplet adjusting agent tends to cover the surface of the droplet. Thus, even when pressure or the like is applied to the droplet, the droplet is less likely to be split, and satellites and mist are less likely to be generated. In addition, the surface of an ink droplet that does not contain the droplet adjusting agent is normally negatively charged. In this case, the electric charge on the surface of the droplet may repel the electric charge on the surface of a recording medium (e.g., a resin recording medium), so that the droplet does not land at a desired position, or even when the droplet lands, adjacent droplets may repel each other, so that the shape of the droplet becomes uneven and the glossiness of the obtained coating film may be lowered. On the other hand, in a droplet of the ink of the present embodiment, the surface of the droplet is covered with the droplet adjusting agent. As a result, the surfaces of the ink droplets are less likely to be charged, and the repulsion between the droplet and the recording medium and the repulsion between the droplets can be suppressed. Therefore, a high-quality printed material having excellent glossiness is obtained. Hereinafter, each component will be described.

### [Droplet Adjusting Agent]

As described above, the droplet adjusting agent is a compound represented by the following General formula (1). The ink may contain only one type of the droplet adjusting agent, or may contain two or more types thereof.

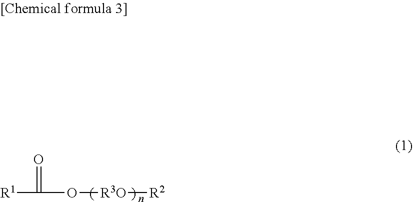

In General formula (1), R¹ represents a substituted or unsubstituted alkyl group, a substituted or unsubstituted alkenyl group, a substituted or unsubstituted alkoxy group, a substituted or unsubstituted alkylthio group, a substituted or unsubstituted aryl group, a substituted or unsubstituted heterocyclic group, or a combination thereof. Examples of the alkyl group or the alkenyl group that may be R¹ include a linear or branched alkyl group or alkenyl group each having 1 or more and 30 or less carbon atoms, and preferably 1 or more and 20 or less carbon atoms. Furthermore, examples of the alkoxy group include a linear or branched alkoxy group having 1 or more and 30 or less carbon atoms, and preferably 1 or more and 20 or less carbon atoms. Examples of the alkylthio group include a linear or branched alkylthio group having 1 or more and 30 or less carbon atoms, and preferably 1 or more and 20 or less carbon atoms. Examples of the aryl group include a phenyl group and a naphthyl group, with a phenyl group being preferred. Examples of the heterocyclic group include groups derived from a 5-membered ring such as furan, tetrahydrofuran, pyrrole, pyrrolidine, thiophene and imidazole, groups derived from a 6-membered ring such as pyridine and pyrrolidine, and groups derived from a fused ring such as quinoline and indole, with groups derived from furan being preferred.

In addition, examples of the substituent group which may be bonded to the above-described alkyl group, alkenyl group, alkoxy group and alkylthio group include a halogen atom, a hydroxy group and the like. In addition, examples of the substituent group which may be bonded to the aryl group or the heterocyclic group include an alkyl group having 1 or more and 12 or less carbon atoms, an alkoxy group having 1 or more and 12 or less carbon atoms, and an alkylthio group having 1 or more and 12 or less carbon atoms.

Among the above, R¹ is preferably an unsubstituted alkyl group or alkenyl group, more preferably an unsubstituted alkyl group or alkenyl group having 1 or more and 20 or less carbon atoms, and even more preferably an unsubstituted alkyl group having 15 or more and 19 or less carbon atoms, from the viewpoint of having high hydrophobicity.

On the other hand, R² represents a hydrogen atom, a substituted or unsubstituted alkyl group, a substituted or unsubstituted alkenyl group, a substituted or unsubstituted alkynyl group, a substituted or unsubstituted aryl group, a substituted or unsubstituted heterocyclic group, or a combination thereof. Examples of the alkyl group that may be R² include linear or branched alkyl groups having 1 or more and 30 or less carbon atoms, and preferably 1 or more and 20 or less carbon atoms. Examples of the alkenyl group include a linear or branched alkenyl group having 1 or more and 30 or less carbon atoms, and preferably 1 or more and 20 or less. Examples of the alkynyl group include a linear or branched alkynyl group having 1 or more and 30 or less carbon atoms, and preferably 1 or more and 20 or less carbon atoms. Examples of the aryl group include a phenyl group and a naphthyl group, and a phenyl group is preferable. Examples of the heterocyclic group include groups derived from a 5-membered ring such as furan, tetrahydrofuran, pyrrole, pyrrolidine, thiophene and imidazole, groups derived from a 6-membered ring such as pyridine and pyrrolidine, and groups derived from a fused ring such as quinoline and indole, with groups derived from furan being preferred.

Examples of the substituent group which may be bonded to the above-described alkyl group, alkenyl group and alkynyl group include a halogen atom, a hydroxy group and the like. In addition, examples of the substituent group which may be bonded to the aryl group or the heterocyclic group include an alkyl group having 1 or more and 12 or less carbon atoms, an alkoxy group having 1 or more and 12 or less carbon atoms, and an alkylthio group having 1 or more and 12 or less carbon atoms.

Among the above, R² is preferably a hydrogen atom or a substituted or unsubstituted alkyl group having 1 or more and 20 or less carbon atoms, more preferably a hydrogen atom or an unsubstituted alkyl group having 1 or more and 5 or less carbon atoms, and particularly preferably a hydrogen atom.

Meanwhile, R³ in General formula (1) represents a substituted or unsubstituted alkylene group having 2 or more and 6 or less carbon atoms, examples of which include an ethylene group (—CH₂CH₂—), a propylene group (—CH₂CH(CH₃)—), a trimethylene group (—CH₂CH₂CH₂—), a tetramethylene group (—CH₂CH₂CH₂CH₂—), a hexamethylene group (—CH₂CH₂CH₂CH₂CH₂CH₂—), and the like. In addition, examples of the substituent group which may be bonded to the alkylene group include a halogen atom and a hydroxy group. Among the above, R³ is preferably an unsubstituted ethylene group, an unsubstituted propylene group, an unsubstituted trimethylene group, or an unsubstituted tetramethylene group, and more preferably an unsubstituted ethylene group or an unsubstituted propylene group.

Further, in the General formula (1), n may be an integer of 1 or more and 50 or less, and preferably 7 or more and 25 or less. When n is more than 50, the foaming power may be increased to cause injection failure. When n is 50 or less, the ejection property is more likely to be satisfactory.

The compound represented by General formula (1) is preferably a compound represented by the following General formula (2).

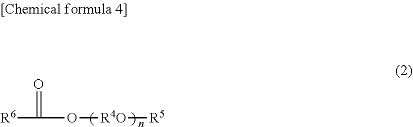

in General formula (2), R⁴ represents a substituted or unsubstituted ethylene group, propylene group, trimethylene group, or tetramethylene group. R⁵ represents a hydrogen atom or a substituted or unsubstituted alkyl group having 1 or more and 20 or less carbon atoms, and substituent groups that may be bonded to the alkyl group are the same as the substituents which may be bonded to R² in the above General formula (1). R⁶ represents an alkyl group having 2 or more and 20 or less carbon atoms, or an alkenyl group having 4 or more and 21 or less carbon atoms. When R⁶ is an alkenyl group, the position of the carbon-carbon double bond is not particularly limited, and R⁶ can be, for example, a group represented by —(CH₂)ₓ—C═C—(CH₂)_{z}H (where x is 1 to 18, z is 1 to 18, and (x+z) satisfies 2 to 19). In the General formula (2), n represents an integer of 1 or more and 30 or less.

Furthermore, the compound represented by the above General formula (1) is more preferably a compound represented by the following General formula (3).

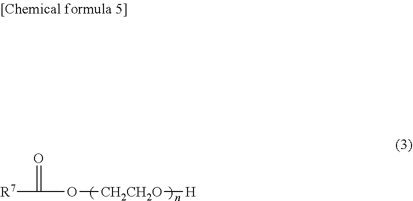

In General formula (3), n represents an integer of 7 or more and 25 or less. R⁷ represents an alkyl group having 15 or more and 19 or less carbon atoms, or alkenyl groups having 15 or more and 19 or less carbon atoms. In a case where R⁷ is an alkenyl group, the position of the carbon-carbon double bond is not particularly limited, and R⁷ can be, for example, a group represented by —(CH₂)_{α}—C═C—(CH₂)_{β}H (where α is 1 to 16, β is 1 to 16, and (α+β) satisfies 13 to 17).

Here, the amount of the droplet adjusting agent in the ink is preferably 0.1% by mass or more and 4.0% by mass or less, more preferably 0.4% by mass or more and 2.0% by mass or less based on the total mass of the ink. When the amount of the droplet adjusting agent is 0.1% by mass or more, the surface of the droplet is easily covered with the droplet adjusting agent when the ink is discharged from an inkjet nozzle, and satellites and mist are less likely to be generated. Furthermore, the glossiness of the obtained image (cured product of the ink) tends to be satisfactory. On the other hand, when the amount of the droplet adjusting agent is 4.0% by mass or less, the discharge properties from inkjet nozzles are less likely to be affected, and printed material with higher quality is more likely to be obtained.

### [Photopolymerizable Compound]

The ink according to the present embodiment contains a photopolymerizable compound. The photopolymerizable compound may be any compound that is polymerized by irradiation with actinic radiation, and the photopolymerizable compound may be a radically polymerizable compound or a cationically polymerizable compound. It is preferable that the photopolymerizable compound is a radically polymerizable compound from the viewpoint of the curability thereof.

The radically polymerizable compound can be a compound (a monomer, an oligomer, a polymer, or a mixture of these) having a radically polymerizable ethylenically unsaturated bond. The ink may contain only one type of radically polymerizable compound as the photopolymerizable compound, or may contain two or more types.

Examples of the compound having a radically polymerizable ethylenically unsaturated bond include unsaturated carboxylic acids and salts thereof, unsaturated carboxylic acid ester compounds, unsaturated carboxylic acid urethane compounds, unsaturated carboxylic acid amide compounds and anhydrides thereof, acrylonitrile, styrene, unsaturated polyesters, unsaturated polyethers, unsaturated polyamides, and unsaturated urethanes. Examples of the unsaturated carboxylic acid include (meth)acrylic acid, itaconic acid, crotonic acid, isocrotonic acid, and maleic acid.

Among the above, the radically polymerizable compound is preferably an unsaturated carboxylic acid ester compound, and more preferably a (meth)acrylate-based compound. Note that in the present specification, the term “(meth)acrylate” includes acrylate, methacrylate, and a mixture thereof.

Examples of the (meth)acrylate-based compound include: monofunctional monomers such as isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethylhexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethylsuccinic acid, 2-(meth)acryloyloxyethylphthalic acid, 2-(meth)acryloyloxyethyl-2-hydroxyethyl-phthalic acid and t-butylcyclohexyl (meth)acrylate;
difunctional monomers such as triethylene glycol di(meth)acrylate, tetraethylene glycol di(meth)acrylate, ethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, bisphenol A-PO adduct di(meth)acrylate, neopentyl glycol hydroxypivalate di(meth)acrylate, polytetramethylene glycol di(meth)acrylate, polyethylene glycol diacrylate, tripropylene glycol diacrylate, and tricyclodecane dimethanol diacrylate;
polyfunctional monomers having three or more functional groups such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerin propoxy tri(meth)acrylate, pentaerythritol ethoxy tetra(meth)acrylate, ethylene oxide-modified trimethylolpropane tri(meth)acrylate, propylene oxide-modified trimethylolpropane tri(meth)acrylate, ethylene oxide-modified pentaerythritol tetraacrylate, caprolactone-modified trimethylolpropane tri(meth)acrylate, and caprolactam-modified dipentaerythritol hexa(meth)acrylate; polymers (oligomers) of the above monomers; mixtures of the above monomers and oligomers; and modified products thereof.

When the (meth)acrylate-based compound is a modified product of the monomer, the modified product may contain a polymerizable functional group other than the unsaturated double bond in the structure thereof. Examples of the (meth)acrylate-based compound having a polymerizable functional group include an amine-modified (meth)acrylate oligomer, an epoxy (meth)acrylate oligomer, an aliphatic urethane (meth)acrylate oligomer, an aromatic urethane (meth)acrylate oligomer, a polyester (meth)acrylate oligomer, and a linear (meth)acryl oligomer.

Among the (meth)acrylate-based compounds, stearyl (meth)acrylate, lauryl (meth)acrylate, isostearyl (meth)acrylate, ethoxydiethylene glycol (meth)acrylate, isobornyl (meth)acrylate, tetraethylene glycol di(meth)acrylate, glycerin propoxy tri(meth)acrylate, tripropylene glycol di(meth)acrylate, polyethylene glycol di(meth)acrylate, (propylene oxide modified) trimethylolpropane tri(meth)acrylate, ditrimethylolpropane tetra(meth)acrylate, amine-modified (meth)acrylate oligomers are preferable from the viewpoint of photosensitivity and the like.

On the other hand, examples of the cationically polymerizable compound which may be a photopolymerizable compound include epoxy compounds, vinyl ether compounds, and oxetane compounds. The ink may contain only one type of cationically polymerizable compound as the photopolymerizable compound, or may contain two or more types thereof.

The epoxy compound may be an aromatic epoxide, a cycloaliphatic epoxide, an aliphatic epoxide, and the like. Among these, aromatic epoxides and alicyclic epoxides are preferable from the viewpoint of increasing the curability of the ink.

The aromatic epoxide may be a di- or polyglycidyl ether obtained by reacting a polyhydric phenol or an alkylene oxide adduct thereof with epichlorohydrin. Examples of the polyhydric phenol or an alkylene oxide adduct thereof to be reacted include bisphenol A or an alkylene oxide adduct thereof. The alkylene oxide in the alkylene oxide adduct may be ethylene oxide, propylene oxide, or the like.

The alicyclic epoxide may be a cycloalkane oxide-containing compound obtained by epoxidizing a cycloalkane-containing compound with an oxidizing agent such as hydrogen peroxide or a peracid. The cycloalkane in the cycloalkane oxide-containing compound may be cyclohexene or cyclopentene.

The aliphatic epoxide may be a di- or polyglycidyl ether obtained by reacting an aliphatic polyhydric alcohol or an alkylene oxide adduct thereof with epichlorohydrin. Examples of the aliphatic polyhydric alcohol include alkylene glycol such as ethylene glycol, propylene glycol, and 1,6-hexanediol. The alkylene oxide in the alkylene oxide adduct may be ethylene oxide, propylene oxide, or the like.

Examples of the vinyl ether compound include: monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl ether-o-propylene carbonate, dodecyl vinyl ether, diethylene glycol monovinyl ether, and octadecyl vinyl ether; and
di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether and trimethylolpropane trivinyl ether. Among these vinyl ether compounds, di- or tri-vinyl ether compounds are preferable in view of curability, adhesion, and the like.

The oxetane compound is a compound having an oxetane ring. Examples thereof include oxetane compounds described in Japanese Unexamined Patent Publication No. 2001-220526, Japanese Unexamined Patent Publication No. 2001-310937, Japanese Unexamined Patent Publication No. 2005-255821. Examples of the oxetane compound are preferably the compounds represented by the General formula (1) described in paragraph 0089, the General formula (2) described in paragraph 0092, the General formula (7) described in paragraph 0107, the General formula (8) described in paragraph 0109, and the General formula (9) described in paragraph 0116 in Japanese Unexamined Patent Publication No. 2005-255821, and the like. General formulae (1), (2), (7), (8), and (9) described in Japanese Unexamined Patent Publication No. 2005-255821 are illustrated below.

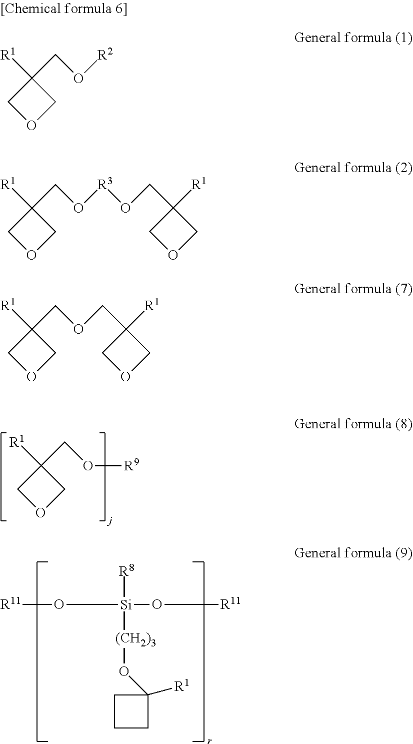

Here, the content of the photopolymerizable compound in the ink may be 70% by mass or more based on the total mass of the ink, but is preferably 75% by mass or more and 98% by mass or less, and more preferably 80% by mass or more and 96% by mass or less, from the viewpoint of the curability of the ink or the like.

### [Photoinitiator]

The photoinitiator may be any compound that can be activated by irradiation with actinic radiation to initiate polymerization of the photopolymerizable compound. The ink may contain only one type of photoinitiator, or may contain two or more types of photoinitiators. The photoinitiator may be of an intramolecular bond cleavage type or an intramolecular hydrogen abstraction type.

Examples of the intramolecular bond cleavage type photoinitiator include: acetophenone-based initiators such as diethoxyacetophenone, 2-hydroxy-2-methyl-1-phenylpropan-1-one, benzyl dimethyl ketal, 1-(4-isopropylphenyl)-2-hydroxy-2-methylpropan-1-one, 4-(2-Hydroxyethoxy)phenyl-(2-hydroxy-2-propyl)ketone, 1-hydroxycyclohexyl-phenylketone, 2-methyl-2-morpholino(4-thiomethylphenyl)propan-1-one, and 2-benzyl-2-dimethylamino-1-(4-morpholinophenyl)-butanone; benzoin-based initiators such as benzoin, benzoin methyl ether, and benzoin isopropyl ether; acylphosphine oxide-based initiators such as 2,4,6-trimethylbenzoin diphenylphosphine oxide; benzyl glyoxyester-based initiators; and methylphenyl glyoxyester-based initiators.

Examples of the intramolecular hydrogen abstraction type photoinitiator include: benzophenone-based initiators such as benzophenon, methyl o-benzoylbenzoate-4-phenylbenzophenone, 4,4′-dichlorobenzophenone, hydroxybenzophenone, 4-benzoyl-4′-methyl-diphenyl sulfide, acrylated benzophenon, 3,3′,4,4′-tetra (t-butylperoxycarbonyl) benzophenon, and 3,3′-dimethyl-4-methoxybenzophenone; thioxanthone-based initiators such as 2-isopropylthioxanthone, 2,4-dimethylthioxanthone, 2,4-diethylthioxanthone, and 2,4-dichlorothioxanthone; aminobenzophenone-based initiators such as Michler's ketone and 4,4′-diethylaminobenzophenone; and 10-butyl-2-chloroacridone, 2-ethylanthraquinone, 9,10-phenanthrenequinone, and camphorquinone.

When the photoinitiator is an acylphosphine oxide or an acyl phosphonate, the sensitivity to actinic radiation becomes satisfactory, and the curability of the ink becomes satisfactory. More preferably, the photoinitiator is bis(2,4,6-trimethylbezoyl)-phenylphosphineoxide, bis(2,6-dimethoxybenzoyl)-2,4,4-trimethyl-pentylphosphineoxide.

Note that the photoinitiator may be a photoacid generator. Examples of the photoacid generator include compounds used for chemically amplified photoresists and photocationic polymerization (see “Organic Materials for Imaging”, edited by The Society for the Study of Organic Electronics Materials, Bunshin Shuppan (1993), pages 187 to 192).

The content of the photoinitiator in the ink is appropriately selected also according to the actinic radiation to be applied for curing the ink, the type of the photopolymerizable compound, and the like. The content of the photoinitiator is preferably 0.1% by mass or more and 10% by mass or less, more preferably 2% by mass or more and 8% by mass or less based on the total mass of the ink.

### [Pigment]

The pigment contained in the ink of the present embodiment is appropriately selected in accordance with the use of the ink. The ink may contain only one type of pigment or two or more types of pigment. The type of the pigment is not particularly limited, and known pigment can be used. For example, organic pigments or inorganic pigments having the following numbers described in the Color Index can be selected.

Examples of red or magenta pigments include Pigment Red 3, 5, 19, 22, 31, 38, 43, 48:1, 48:2, 48:3, 48:4, 48:5, 49:1, 53:1, 57:1, 57:2, 58:4, 63:1, 81, 81:1, 81:2, 81:3, 81:4, 88, 104, 108, 112, 122, 123, 144, 146, 149, 166, 168, 169, 170, 177, 178, 179, 184, 185, 208, 216, 226, 257, Pigment Violet 3, 19, 23, 29, 30, 37, 50, 88, Pigment Orange 13, 16, 20, and 36, and solid solutions of any two or more of these magenta pigments.

Examples of blue or cyan pigment include Pigment Blue 1, 15, 15:1, 15:2, 15:3, 15:4, 15:6, 16, 17-1, 22, 27, 28, 29, 36, 60 and the like.

Examples of green pigments include Pigment Green 7, 26, 36, and 50. Examples of yellow pigments include Pigment Yellow 1, 3, 12, 13, 14, 17, 34, 35, 37, 55, 74, 81, 83, 93, 94, 95, 97, 108, 109, 110, 137, 138, 139, 150,153, 154, 155, 157, 166, 167, 168, 180, 185, and 193.

Examples of the black pigment include Pigment Black 7, 28, and 26. As the white pigment, titanium oxide (particularly, rutile-type titanium dioxide) can also be used.

The volume mean particle diameter of the pigment measured by a dynamic scattering method or a laser diffraction method is preferably 0.08 μm or more and 0.5 μm or less. The maximum particle size of the pigment is preferably 0.3 μm or more and 10 μm or less, more preferably 0.3 μm or more and 3 μm or less. When the particle diameter of the pigment is within the above range, the ink is easily discharged from an inkjet nozzle. Furthermore, the storage stability of the ink is more likely to be satisfactory.

The amount of the pigment in the ink is preferably 0.1% by mass or more and 20% by mass or less, more preferably 0.4% by mass or more and 10% by mass or less. When the amount of the pigment is within the above range, an image having a desired color is easily obtained. On the other hand, the viscosity of the ink does not excessively increase, making it easier to discharge the ink from inkjet nozzles.

### [Pigment-Dispersing Agent]

The pigment-dispersing agent is appropriately selected according to the type of the pigment. The ink may contain only one type of pigment-dispersing agent or two or more types of pigment-dispersing agent.

Examples of the pigment-dispersing agent include hydroxyl group-containing carboxylic acid esters, salts of long-chain polyaminoamides and high-molecular-weight acid esters, salts of high-molecular-weight polycarboxylic acids, salts of long-chain polyaminoamides and polar acid esters, high-molecular-weight unsaturated acid esters, polymer copolymers, modified polyurethanes, modified polyacrylates, polyether ester-type anionic surfactants, naphthalenesulfonic acid formalin condensate salts, aromatic sulfonic acid formalin condensate salts, polyoxyethylene alkyl phosphate esters, polyoxyethylene nonylphenyl ether, and stearylamine acetate. Examples of commercially available pigment-dispersing agent include Solsperse series manufactured by Avecia Co., Ltd. and PB series manufactured by Ajinomoto Fine-Techno Co., Inc.

The ink may further contain a known dispersion aid, as necessary. The dispersion aid is appropriately selected depending on the type of the pigment. An example thereof includes SOLSPERSE 22000 (Disazo Yellow Intermediate, manufactured by Lubrizol Corporation) which is generally used for dispersing a yellow pigment. The total amount of the pigment-dispersing agent and the dispersion aid is preferably 1% by mass or more and 50% by mass or less based on the pigment.

### [Gelling Agent]

The ink may further contain a gelling agent, as necessary. The gelling agent in the present specification is “an organic substance that is solid at room temperature and becomes liquid when heated, and is a compound having a function of causing the actinic radiation-curable inkjet ink to undergo a temperature-induced reversible sol-gel phase transition”.

The gelling agent is preferably a compound that crystallizes at a temperature equal to or lower than the gelation temperature of the ink. The gelation temperature of the ink refers to a temperature at which the gelling agent undergoes a phase transition from sol to gel and the viscosity of the ink suddenly changes when the ink that has been solated or liquefied by heating is cooled. Specifically, the solated or liquefied ink is cooled while measuring the viscosity with a viscoelasticity measurement apparatus (for example, MCR300, manufactured by Physica), and the temperature at which the viscosity rapidly increases is taken as the gelation temperature of the ink.

When the gelling agent is crystallized in the ink, a structure in which the photopolymerizable compound is included in a three dimensional space formed by the gelling agent crystallized in a plate shape may be formed. In the present specification, such a structure is also referred to as a “card house structure”. Then, when the card house structure is formed in the ink, the photopolymerizable compound is held in the space. Therefore, the ink droplet is less likely to wet-spread, and the pinning properties of the ink are enhanced. When the pinning properties of the ink are enhanced, the ink droplets landed on the recording medium are less likely to coalesce with each other, and thus a higher-definition image can be formed.

In order to hold the photopolymerizable compound in the card house structure, the photopolymerizable compound and the gelling agent are preferably compatible with each other in the ink. In addition, it is preferable that the compatibility between the photopolymerizable compound and the gelling agent is satisfactory also from the viewpoint of stably discharging droplets of the ink from an inkjet nozzle.

Here, examples of the gelling agent include the following: aliphatic ketone compounds; aliphatic ester compounds; petroleum waxes such as paraffin wax, microcrystalline wax, and petrolactam; vegetable waxes such as candelilla wax, carnauba wax, rice wax, Japan wax, jojoba oil, jojoba solid wax, and jojoba ester; animal waxes such as beeswax, lanolin, and spermaceti; mineral waxes such as montan wax and hydrogenated wax; hydrogenated castor oil or hydrogenated castor oil derivatives; modified waxes such as montan wax derivatives, paraffin wax derivatives, microcrystalline wax derivatives, and polyethylene wax derivatives; higher fatty acids such as behenic acid, arachidic acid, stearic acid, palmitic acid, myristic acid, lauric acid, oleic acid, and erucic acid; higher alcohols such as stearyl alcohol and behenyl alcohol; hydroxystearic acids such as 12-hydroxystearic acid; 12-hydroxystearic acid derivatives; fatty acid amides such as lauric acid amide, stearic acid amide, behenic acid amide, oleic acid amide, erucic acid amide, ricinoleic acid amide, and 12-hydroxystearic acid amide (for example, the Nikkaamide series manufactured by Nippon Kasei Co., Ltd., the ITOWAX series manufactured by Ito Oil Mills, and the FATTYAMID series manufactured by Kao Corporation); N-substituted fatty acid amides such as N-stearylstearic acid amide and N-oleylpalmitic acid amide; special fatty acid amides such as N,N′-ethylenebisstearylamide, N,N′-ethylenebis-12-hydroxystearylamide, and N,N′-xylylenebisstearylamide; higher amines such as dodecylamine, tetradecylamine, and octadecylamine; fatty acid ester compounds such as stearyl stearic acid, oleyl palmitic acid, glycerin fatty acid esters, sorbitan fatty acid esters, propylene glycol fatty acid esters, ethylene glycol fatty acid esters, and polyoxyethylene fatty acid esters (e.g., the EMALLEX series manufactured by Nippon Emulsion Co., Ltd., the RIKEMAL series manufactured by Riken Vitamin Co., Ltd., and the POEM series manufactured by Riken Vitamin Co., Ltd.); sucrose fatty acid esters such as sucrose stearic acid and sucrose palmitic acid (e.g., the RYOTO Sugar Ester series manufactured by Mitsubishi Chemical Foods Corporation); synthetic waxes such as polyethylene wax and α-olefin maleic anhydride copolymer wax (e.g., Baker-Petrolite's UNILIN series); dimer acid; dimer diol (e.g., Croda's PRIPOR series); fatty acid inulins such as inulin stearate; fatty acid dextrins such as dextrin palmitate and dextrin myristate (e.g., Chiba Flour Milling Co., Ltd.'s Leopearl series); glyceryl behenate eicosandioate; eicosanepolyglyceryl behenate (such as the Nomcoat series manufactured by Nisshin Oillio Co., Ltd.); amide compounds such as N-lauroyl-L-glutamic acid dibutylamide and N-(2-ethylhexanoyl)-L-glutamic acid dibutylamide (available from Ajinomoto Fine-Techno); dibenzylidene sorbitols such as 1,3:2,4-bis-O-benzylidene-D-glucitol (Gelall D, available from New Japan Chemical Co., Ltd.); low molecular weight oil gelling agents described in Japanese Unexamined Patent Publication No. 2005-126507, Japanese Unexamined Patent Publication No. 2005-255821 and Japanese Unexamined Patent Publication No. 2010-111790; and the like.

The gelling agent preferably contains a linear or branched alkyl group having 12 or more and 26 or less carbon atoms in the molecular structure. When the gelling agent contains the alkyl group, the above-described “card house structure” is easily formed. When the gelling agent contains a linear alkyl group having 12 or more and 26 or less carbon atoms in the molecular structure, the card house structure is more easily formed.

Specific example of the gelling agent containing a linear or branched alkyl group having 12 or more and 26 or less carbon atoms include aliphatic ketone compounds, aliphatic ester compounds, higher fatty acids, higher alcohols, fatty acid amides, and the like, each having the above alkyl group.

The gelling agent is more preferably an aliphatic ketone compound or an aliphatic ester compound, and is preferably a compound represented by the following General formula (G1) or (G2).

R⁵—CO—R⁶ General formula (G1):

R⁷—COO—R⁸ General formula (G2):

In the General formula (G1) and (G2), R⁵ to R⁸ each independently represent a linear or branched alkyl group having 12 or more and 26 or less carbon atoms. R⁵ to R⁸ may each partially include a branched chain portion.

The alkyl group represented by R⁵ and R⁶ in General formula (G1) are not particularly limited, but are preferably alkyl groups having 12 or more and 26 or less carbon atoms and not including a branched chain.

Examples of the aliphatic ketone compound represented by the general formula (G1) include 18-pentatriacontanone (C17-C17), dilignoceryl ketone (C24-C24), dibehenyl ketone (C22-C22), distearyl ketone (C18-C18), dieicosyl ketone (C20-C20), dipalmityl ketone (C16-C16), dimyristyl ketone (C14-C14), dilauryl ketone (C12-C12), lauryl myristyl ketone (C12-C14), lauryl palmityl ketone (C12-C16), myristyl palmityl ketone (C14-C16), myristyl stearyl ketone (C14-C18), myristyl behenyl ketone (C14-C22), palmityl stearyl ketone (C16-C18), palmityl behenyl ketone (C16-C22), and stearyl behenyl ketone (C18-C22).

Examples of commercially available products of the compound represented by General formula (G1) include 18-Pentatriacontanon (manufactured by Alfa Aeser), Hentriacontan-16-on (manufactured by Alfa Aeser), and Kao Wax T1 (manufactured by Kao Corporation). The ink may contain only one type of aliphatic ketone compound or may contain two or more types of aliphatic ketone compounds as the gelling agent.

On the other hand, in General formula (G2), the alkyl groups represented by R⁷ and R⁸ are not particularly limited, but are preferably alkyl groups having 12 to 26 carbon atoms and not including a branched chain.

Examples of the aliphatic ester compound represented by general formula (G2) include behenyl behenate (C21-C22), icosanoic acid icosyl (C19-C20), stearyl stearate (C17-C18), palmityl stearate (C17-C16), lauryl stearate (C17-C12), behenyl stearate (C17-C22), cetyl palmitate (C15-C16), stearyl palmitate (C15-C18), myristyl myristate (C13-C14), cetyl myristate (C13-C16), octyldodecyl myristate (C13-C20), stearyl oleate (C17-C18), stearyl erucate (C21-C18), stearyl linoleate (C17-C18), behenyl oleate (C18-C22), myricyl cerotate (C25-C16), stearyl montanate (C27-C18), behenyl montanate (C27-C22), arachidyl linoleate (C17-C20), palmityl triacontanoate (C29-C16), and the like.

Examples of commercially available products of the aliphatic ester compound represented by General formula (G2) include UNISTER M-2222SL (manufactured by NOF Corporation), EXCEPARL SS (manufactured by Kao Corporation), EMALEX CC-18 (manufactured by Nihon Emulsion Co., Ltd), AMREPS PC (manufactured by Higher Alcohol Industries, Ltd), EXCEPARL MY-M (manufactured by Kao Corporation), SPERMACETI (manufactured by NOF Corporation), EMALEX CC-10 (manufactured by Nihon Emulsion Co., Ltd), and WE (manufactured by NOF Corporation). These commercially available products are often mixtures of two or more types, and may be separated and purified as necessary. Furthermore, the ink may contain, as a gelling agent, only one type of aliphatic ester compound, or two or more types of aliphatic ester compounds.

The content of the gelling agent in the ink is preferably 0.5% by mass or more and 10% by mass or less, more preferably 1% by mass or more and 7% by mass or less based on the total mass of the ink.

### [Other Components]

The ink may further contain a photoinitiator auxiliary, a polymerization inhibitor, and the like, as necessary, in addition to the above-described components. Examples of the photoinitiator auxiliary include tertiary amine compounds. Among these, aromatic tertiary amine compound is preferable. Examples of the aromatic tertiary amine compound include N,N-dimethylaniline, N,N-diethylaniline, N,N-dimethyl-p-toluidine, N,N-dimethylamino-p-benzoic acid ethyl ester, N,N-dimethylamino-p-benzoic acid isoamylethyl ester, N,N-dihydroxyethylaniline, triethylamine, and N,N-dimethylhexylamine. Among these, N,N-dimethylamino-p-benzoic acid ethyl ester and N,N-dimethylamino-p-benzoic acid isoamylethyl ester are preferable. The ink may contain only one type of photoinitiator aid, or may contain two or more types.

Examples of the polymerization inhibitor include (alkyl)phenols, hydroquinone, catechol, resorcinol, p-methoxyphenol, t-butylcatechol, t-butylhydroquinone, pyrogallol, 1,1-picrylhydrazyl, phenothiazine, p-benzoquinone, nitrosobenzene, 2,5-di-t-butyl-p-benzoquinone, dithiobenzoyl disulfide, picric acid, cupferron, aluminum N-nitrosophenylhydroxylamine, tri-p-nitrophenylmethyl, N-(3-oxyanilino-1,3-dimethylbutylidene) anilineoxide, dibutylcresol, cyclohexanoneoximecresol, guaiacol, o-isopropylphenol, butyraldoxime, methylethylketoxime, cyclohexanoneoxime and the like.

The ink may further contain other components, as necessary. The other components may be various additives, resin, and the like. Examples of the additive include a surfactant, a leveling additive, a matting agent, an ultraviolet absorber, an infrared rays absorber, an antibacterial agent, and a basic compound for enhancing the storage stability of the ink. Examples of the basic compound include basic alkali metal compounds, basic alkaline earth metal compounds, and basic organic compounds such as amines. Examples of the other resin include a resin for adjusting physical property of a cured product, and the like, and include, for example, a polyester-based resin, a polyurethane-based resin, a vinyl-based resin, an acrylic-based resin, a rubber-based resin, and the like.

### [Physical Property of Ink]

The ink described above has a different viscosity between when the ink includes the gelling agent and when the ink does not include the gelling agent. For example, the viscosity of an ink that does not contain a gelling agent at 25° C. is preferably 1 mPa s or more and 30 mPa-s or less and more preferably 5 mPa-s or more and 20 mPa-s or less. When the viscosity is within the above range, the ink is easily discharged from an inkjet nozzle, and ink droplets are easily generated. The viscosity is a value measured with a rheometer. As the rheometry, stress-controlled rheometry PhysicaMCR series manufactured by Anton Paar Co., Ltd. can be used. The cone plate may have a 75 mm radius and a cone angle of 1.0°. The viscosity can be adjusted by, for example, the type and amount of the photopolymerizable compound.

On the other hand, when the ink contains a gelling agent, the ink undergoes a temperature-induced reversible sol-gel phase transition. The actinic radiation-curable ink which undergoes sol-gel phase transition is a liquid (sol) at a high temperature (for example, about 80° C.), and thus can be discharged in a sol state from an inkjet recording head. When an actinic radiation-curable inkjet ink is discharged at high temperature, an ink droplet (dot) lands on a recording medium and then is naturally cooled to gel. Thus, coalescence of adjacent dots can be suppressed and image quality can be improved.

The ink containing a gelling agent preferably has a viscosity of the ink at high temperature of a certain level or lower in order to enhance the ejection property of ink droplets. To be specific, the viscosity of the ink at 80° C. is preferably 3 mPa·s or more and 20 mPa·s or less. On the other hand, in order to suppress coalescence of adjacent dots, the viscosity of the ink at room temperature after landing is preferably a certain level or more. To be specific, the viscosity of the ink at 25° C. is 1000 mPa·s or more.

The gelation temperature of the ink is preferably 30° C. or more and less than 100° C., more preferably 50° C. or more and 65° C. or less. When the gelation temperature of the ink is too high, gelation tends to occur at the time of ejection, so that the ejection property tends to be low. On the other hand, when the gelation temperature of the ink is excessively low, the ink is less likely to be rapidly gelled after landing on a recording medium. Note that the gelation temperature is a temperature at which the ink in a sol state is gelled and its fluidity decreases in a process of cooling the ink.

The viscosity at 80° C., the viscosity at 25° C., and the gelation temperature of the inkjet ink can be determined by measuring a temperature change in the dynamic viscoelasticity of the ink with a rheometer. Specifically, a temperature change curve of viscosity is obtained when the ink is heated to 100° C. and cooled to 20° C. under conditions of a shear rate of 11.7 (/s) and a temperature lowering rate of 0.1° C./s. The viscosity at 80° C. and the viscosity at 25° C. are the viscosities at 80° C. and 25° C. in the temperature change curve. The gelation temperature is defined as a temperature at which the viscosity becomes 200 mPa-s in the temperature change curve of viscosity. The rheometer is the same as described above.

The above-described ink having a sol-gel phase transition can suppress coalescence of ink droplets by discharging ink droplets that are in a liquid state at a high temperature, landing the ink droplets on a recording medium, and at the same time, cooling and gelling the ink droplets. Thus, a high-definition image can be formed even when high-speed recording is performed.

### [Method for Preparing Inkjet Ink]

The ink is obtained by mixing the droplet adjusting agent, the photopolymerizable compound, the photoinitiator, the pigment, and the pigment-dispersing agent, which are described above, and as necessary, a gelling agent and the like. The mixing method is not particularly limited, but for example, it is preferable to prepare a composition in which a pigment, a pigment-dispersing agent, and the like are dispersed in a part of the photopolymerizable compound and mix the composition with other components. The obtained ink is preferably filtered with a predetermined filter.

### 2. Method for Producing Printed Material

The method for producing printed material according to the present embodiment includes at least the following two steps.
(1) Discharging ink droplets of the ink from an inkjet recording head to cause the ink droplets to land on a recording medium
(2) Irradiating the ink droplets having landed on the recording medium with actinic radiation to cure the ink droplets

### [Step (1)]

In this step, ink droplets of the above-described ink are discharged from an inkjet recording head and allowed to land on a recording medium at positions corresponding to an image to be formed.

The discharge method from the inkjet recording head may be either an on-demand method or a continuous method. The inkjet head of the on-demand system may be any of an electro-mechanical conversion system such as a single cavity type, a double cavity type, a bender type, a piston type, a share mode type, and a shared wall type, and an electro-thermal conversion system such as a thermal inkjet type and a bubble jet (Bubble Jet is a registered trademark of Canon Inc) type.

An ink droplet not containing a gelling agent can be discharged from an inkjet head at room temperature, but an ink droplet containing a gelling agent can be discharged from an inkjet head in a heated state to enhance discharge stability. The temperature of the ink during the discharge is not particularly limited, but is preferably 35° C. or more and 100° C. or less in a case of using an ink containing a gelling agent, and is more preferably 35° C. or more and 80° C. or less in order to further enhance discharge stability. In particular, it is preferable to perform ejection at an ink temperature at which the viscosity of the ink becomes 7 mPa s or more and 15 mPa s or less, and more preferably 8 mPa s or more and 13 mPa s or less.

The ink can be heated in an inkjet recording head of an inkjet recording apparatus, an ink channel connected to the inkjet recording head, an ink tank connected to the ink channel, or the like.

The amount per droplet discharged from each nozzle of the inkjet recording head depends on the image resolution, but is preferably 0.5 pl or more and 10 pl or less, and more preferably 0.5 pl or more and 2.5 pl or less in order to form a high-definition image.

Note that in a case where the ink contains a gelling agent, it is preferable that the ink droplet landed on the recording medium undergo sol-gel phase transition by cooling so as to be rapidly gelled. Thus, the ink droplet can be pinned without being diffused. Furthermore, since oxygen is less likely to enter the ink droplet, curing of the photopolymerizable compound is less likely to be inhibited by oxygen.

The recording medium may be either paper or a resin film. Examples of the paper include coated printing paper and coated printing paper B. In addition, examples of the resin film include a polyethylene terephthalate film, a polypropylene film, and a vinyl chloride film.

The conveyance speed of the recording medium is preferably 30 to 120 m/min.

### [Step (2)]

The ink droplets landed on the recording medium are irradiated with actinic radiation to polymerize the photopolymerizable compound contained in the ink droplets, thereby curing the ink droplets.

The actinic radiation can be selected from, for example, an electron beam, an ultraviolet ray, visible light, an α-ray, a γ-ray, an X-ray, and the like. Among these, an ultraviolet ray or visible light is preferred. An LED light source that emits light that is preferably ultraviolet rays or visible light and has peak wavelength in the range of 360 nm to 500 nm is more preferable. An LED emits less radiant heat than a conventional light source (e.g., a metal halide lamp). Therefore, upon irradiation with actinic radiation, the ink is less likely to be dissolved, and gloss unevenness and the like are less likely to occur.

In the case of irradiation with light having peak wavelengths in the range of 360 nm to 410 nm, the peak irradiance at the surface of the recording medium or the surface of the ink droplets is preferably 0.5 W/cm² or more and 10.0 W/cm² or less. The peak illumination is more preferably equal to or higher than 1.0 W/cm² and equal to or lower than 5.0 W/cm².

The irradiation with actinic radiation is preferably performed between 0.001 seconds and 1.0 seconds after the ink lands on the recording medium. In order to form a high-definition image, it is more preferable to perform the irradiation between 0.001 seconds and 0.5 seconds.

On the other hand, the irradiation with actinic radiation may be performed in two stages. In this case, it is possible to temporarily cure the ink by irradiating the ink with actinic radiation between 0.001 seconds and 2.0 seconds after the ink has landed on the recording medium, and to fully cure the ink by further irradiating the ink with actinic radiation after completion of all printing. When the irradiation with actinic radiation is divided into two stages, the curing shrinkage of the ink is less likely to occur.

### Examples

Hereinafter, the present invention will be specifically described with reference to examples, but the embodiments of the present invention are not limited to these examples.

### 1. Material Preparation

The following materials were prepared.

### <Pigment>

Yellow pigment: VERSAL YELLOW 4GM (Synthesia)

### <Photopolymerizable Compound>

Phenol EO-modified acrylate: Miramer (registered trademark) M144 (manufactured by MIWON)
Polyethylene glycol #400 diacrylate (PEGDA)
4EO modified pentaerythritol tetraacrylate (4EO modified PETA)
3PO modified trimethylolpropane triacrylate (3PO modified TMPTA)

### <Photopolymerization Initiator>

Photopolymerization initiator: IRGACURE (registered trademark) 819 (manufactured by BASF)

### <Pigment-Dispersing Agent>

Ajisper PB821 (manufactured by Ajinomoto Fine-Techno Co., Inc)

### <Photopolymerization Inhibitor>

Photopolymerization inhibitor: Irgastab (registered trademark) UV10 (manufactured by BASF)

### <Droplet Adjusting Agent (Compound Represented by General Formula (1))>

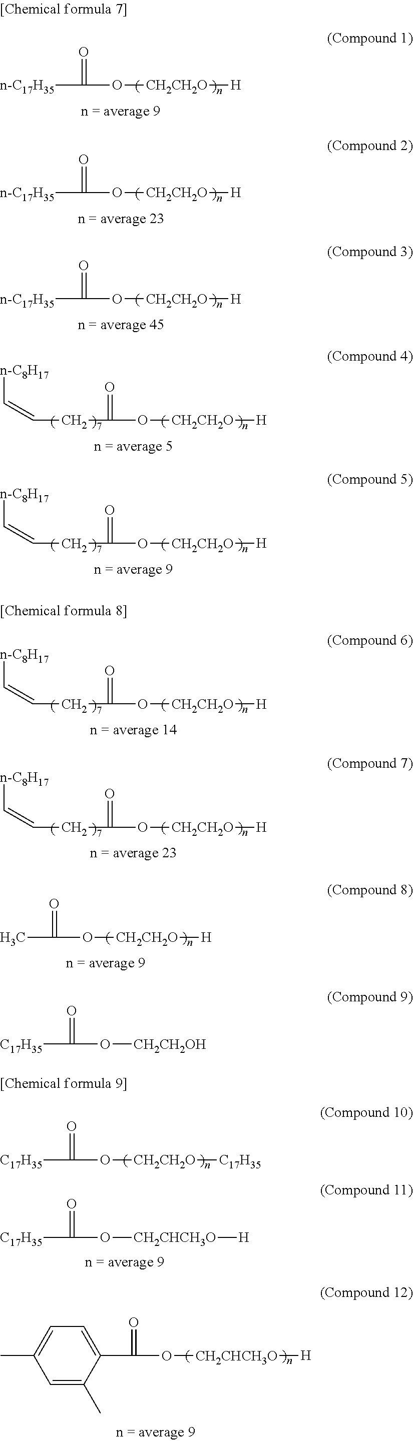

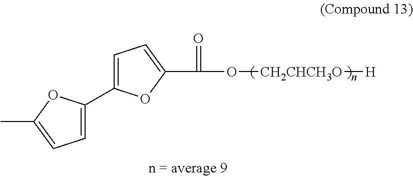

### <Droplet Adjusting Agent (Other Compounds)>

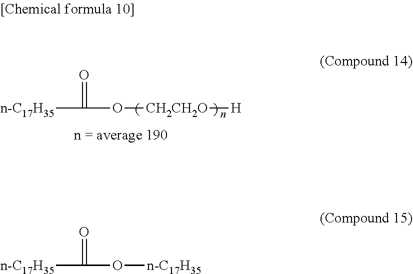

### <Gelling Agent>

Gelling agent: “AMREPS PC” (cetyl palmitate, manufactured by Kokyu Alcohol Kogyo Co., Ltd.)

### 2. Ink Preparation

### (1) Preparation of Pigment Dispersion Liquid

As the materials of a pigment dispersion liquid, components were mixed at a composition ratio shown below. Next, the mixture and 0.3 mm zirconiabeads (YTZ balls, manufactured by Nikkato Corporation) were placed in a 100 mL plastic container. The mixture was dispersed for 3 hours in a paint shaker, and then, the zirconia beads were removed to obtain a pigment dispersion composition 1.

### (Composition of Pigment Dispersion Liquid)

Polymeric pigment-dispersing agent: Ajisper PB821 (manufactured by Ajinomoto Fine-Techno Co., Inc) 6.5 parts by mass
Phenol EO-modified acrylate: Miramer (registered trademark) M144 (manufactured by MIWON) 73.2 parts by mass
Photopolymerization inhibitor: Irgastab (registered trademark) UV10 (manufactured by BASF) 0.3 parts by mass

### (2) Preparation of Inks 1 to 20

The components were mixed in the composition ratios listed in Table 1, and the mixture was stirred at 105° C. for 45 minutes. Thereafter, the mixtures were each filtered through a 3-μm filter (Teflon (registered trademark)) produced by ADVANTEC) to prepare inks 1 to 20.

### 3. Evaluation

The satellite and mist evaluation and the image gloss of the obtained printed material were performed by the following methods.

### (1) Satellite and Mist Evaluation

The ink was filled in an inkjet ejection evaluation apparatus having an inkjet recording head provided with a piezo-type inkjet nozzle. Then, one droplet of the ink was ejected from the ink ejection evaluation apparatus, and the state after the discharge was observed with a JetXpert droplet observation apparatus (manufactured by ImageXpert). Then, satellites and mist were evaluated according to the following standard. ⊚, ∘, and Δ are acceptable.
⊚: generation of any of the satellite and the mist cannot be confirmed
∘: a total number of satellites and mist for one main droplet is greater than or equal to 1 and less than or equal to 2
Δ: the total number of satellites and mist for one main droplet is 3 or more and 5 or less
x: the total number of satellites and mist is 6 or more for one main droplet

### (2) Evaluation of Glossiness

A monochrome image was formed using an inkjet recording apparatus of a line recording system. An ink supply system of the inkjet recording apparatus is configured by an ink tank, a supply pipe, a sub ink tank immediately before a head, a tube with a filter, and a piezo head (inkjet recording head), all of which are connected in this order. The inkjet ink obtained above was supplied to the ink supply system of an inkjet recording apparatus, and printing was performed.

The inkjet recording head used had 1776 nozzles, and two inkjet heads manufactured by Konica Minolta, Inc. having 600 dpi resolutions were modularized as one set so as to be 1200 dpi. The voltage applied was adjusted so that the droplet amount of one droplet was 3.5 pl, and an image was formed. The dpi stands for dots per 2.54 cm. The image formation was performed under an environment of 23° C. and 55% RH.

Double-sided YUPO SUPER YUPO DOUBLE FRBW 130 μm was prepared as a recording medium. The temperature of the recording medium was adjusted to 30° C. by the temperature controller. The conveyance speed of the recording medium was 1000 mm/s. Then, ink droplets were discharged onto the recording medium from the inkjet recording head to form a solid image.

After the image formation, the recording medium was irradiated with actinic radiation emitted from an LED lamp (manufactured by KYOCERA Corporation, 8 W/cm², wavelength 450 nm, irradiation range 68 mm, distance from the LED lamp to the recording medium surface 50 mm, illumination intensity 2.0 W/cm² on the recording medium) disposed at a downstream part of the inkjet recording apparatus, such that an accumulated light amount became 350 mJ. The gloss value of the obtained image was measured using a gloss meter (PG-IIM manufactured by Nippon Denshoku Industries Co., Ltd), and evaluation was performed according to the following evaluation criterion. ⊚, ∘, and Δ are acceptable.
⊚: gloss value of 30 or more and less than 40
∘: gloss value of 25 or more and less than 30 or 40 or more and less than 45
Δ: gloss value of 20 or more and less than 25 or 45 or more and less than 50
x: gloss value of less than 20 or 50 or more

TABLE 1

| | | | | | Photopolymerizable | | | | |
|---|---|---|---|---|---|---|---|---|---|
| | | | | Pigment | compound | | | | |
| | | | | disper- | | 4EO | 3EO | Photo- | Photo- |
| | | Droplet adjusting | | sion | | modi- | modi- | polymeri- | polymeri- |
| | | agent | | composi- | | fied | fied | zation | zation |
| | | | Amount | tion 1 | PEGDA | PETA | TMPTA | initiator | inhibitor |
| | | | (parts | (parts | (parts | (parts | (parts | (parts | (parts |
| | | | by | by | by | by | by | by | by |
| | | Type | mass) | mass) | mass) | mass) | mass) | mass) | mass) |
| Example | Ink | Compound | 0.6 | 10.0 | 39.3 | 25.0 | 14.0 | 6.0 | 0.1 |
| | 1 | 1 | | | | | | | |
| Example | Ink | Compound | 0.6 | ↑ | ↑ | ↑ | ↑ | ↑ | ↑ |
| | 2 | 2 | | | | | | | |
| Example | Ink | Compound | 0.6 | ↑ | ↑ | ↑ | ↑ | ↑ | ↑ |
| | 3 | 3 | | | | | | | |
| Example | Ink | Compound | 0.6 | ↑ | ↑ | ↑ | ↑ | ↑ | ↑ |
| | 4 | 4 | | | | | | | |
| Example | Ink | Compound | 0.6 | ↑ | ↑ | ↑ | ↑ | ↑ | ↑ |
| | 5 | 5 | | | | | | | |
| Example | Ink | Compound | 0.6 | ↑ | ↑ | ↑ | ↑ | ↑ | ↑ |
| | 6 | 6 | | | | | | | |
| Example | Ink | Compound | 0.6 | ↑ | ↑ | ↑ | ↑ | ↑ | ↑ |
| | 7 | 7 | | | | | | | |
| Example | Ink | Compound | 0.6 | ↑ | ↑ | ↑ | ↑ | ↑ | ↑ |
| | 8 | 8 | | | | | | | |
| Example | Ink | Compound | 0.6 | ↑ | ↑ | ↑ | ↑ | ↑ | ↑ |
| | 9 | 9 | | | | | | | |
| Example | Ink | Compound | 0.6 | ↑ | ↑ | ↑ | ↑ | ↑ | ↑ |
| | 10 | 10 | | | | | | | |
| Example | Ink | Compound | 0.6 | ↑ | ↑ | ↑ | ↑ | ↑ | ↑ |
| | 11 | 11 | | | | | | | |
| Example | Ink | Compound | 0.6 | ↑ | ↑ | ↑ | ↑ | ↑ | ↑ |
| | 12 | 12 | | | | | | | |
| Example | Ink | Compound | 0.6 | ↑ | ↑ | ↑ | ↑ | ↑ | ↑ |
| | 13 | 13 | | | | | | | |
| Example | Ink | Compound | 4.0 | ↑ | 35.9 | ↑ | ↑ | ↑ | ↑ |
| | 14 | 1 | | | | | | | |
| Example | Ink | Compound | 0.05 | ↑ | 39.85 | ↑ | ↑ | ↑ | ↑ |
| | 15 | 1 | | | | | | | |
| Example | Ink | Compound | 6.0 | ↑ | 39.3 | ↑ | ↑ | ↑ | ↑ |
| | 16 | 1 | | | | | | | |
| Example | Ink | Compound | 0.6 | ↑ | 39.9 | ↑ | ↑ | ↑ | ↑ |
| | 17 | 1 | | | | | | | |
| Example | Ink | Compound | 0.6 | ↑ | ↑ | ↑ | ↑ | ↑ | ↑ |
| | 18 | 2 | | | | | | | |
| Comp. | Ink | Compound | 0.6 | ↑ | 39.3 | ↑ | ↑ | ↑ | ↑ |
| example | 19 | 14 | | | | | | | |
| Comp. | Ink | Compound | 0.6 | ↑ | ↑ | ↑ | ↑ | ↑ | ↑ |
| example | 20 | 15 | | | | | | | |

| | | | | | Proportion | | |
|---|---|---|---|---|---|---|---|
| | | | | Photo- | of com- | | |
| | | | | polymeri- | pound re- | | |
| | | Gelling agent | | zable | presented | Evaluation | |
| | | | Amount | compound | by | Satel- | |
| | | | (parts | proportion | formula 1 | lite | |
| | | | by | (% by | (% by | and | Glossi- |
| | | Type | mass) | mass) | mass) | mist | ness |
| Example | Ink | AMR | 5.0 | >70 | 0.6 | ⊚ | ⊚ |
| | 1 | EPS | | | | | |
| | | PC | | | | | |
| Example | Ink | ↑ | ↑ | >70 | 0.6 | ⊚ | ⊚ |
| | 2 | | | | | | |
| Example | Ink | ↑ | ↑ | >70 | 0.6 | ⊚ | ⊚ |
| | 3 | | | | | | |
| Example | Ink | ↑ | ↑ | >70 | 0.6 | ⊚ | ⊚ |
| | 4 | | | | | | |
| Example | Ink | ↑ | ↑ | >70 | 0.6 | ⊚ | ◯ |
| | 5 | | | | | | |
| Example | Ink | ↑ | ↑ | >70 | 0.6 | ◯ | ◯ |
| | 6 | | | | | | |
| Example | Ink | ↑ | ↑ | >70 | 0.6 | ◯ | ⊚ |
| | 7 | | | | | | |
| Example | Ink | ↑ | ↑ | >70 | 0.6 | Δ | ◯ |
| | 8 | | | | | | |
| Example | Ink | ↑ | ↑ | >70 | 0.6 | ◯ | ◯ |
| | 9 | | | | | | |
| Example | Ink | ↑ | ↑ | >70 | 0.6 | ◯ | ◯ |
| | 10 | | | | | | |
| Example | Ink | ↑ | ↑ | >70 | 0.6 | Δ | ◯ |
| | 11 | | | | | | |
| Example | Ink | ↑ | ↑ | >70 | 0.6 | Δ | ◯ |
| | 12 | | | | | | |
| Example | Ink | ↑ | ↑ | >70 | 0.6 | ◯ | Δ |
| | 13 | | | | | | |
| Example | Ink | ↑ | ↑ | >70 | 4.0 | ◯ | ◯ |
| | 14 | | | | | | |
| Example | Ink | ↑ | ↑ | >70 | 0.05 | ◯ | Δ |
| | 15 | | | | | | |
| Example | Ink | ↑ | ↑ | >70 | 6.0 | ◯ | Δ |
| | 16 | | | | | | |
| Example | Ink | — | — | >70 | 0.6 | ◯ | Δ |
| | 17 | | | | | | |
| Example | Ink | — | — | >70 | 0.6 | ◯ | Δ |
| | 18 | | | | | | |
| Comp. | Ink | AMR | 5.0 | >70 | — | X | X |
| example | 19 | EPS | | | | | |
| | | PC | | | | | |
| Comp. | Ink | ↑ | ↑ | >70 | — | X | X |
| example | 20 | | | | | | |

As illustrated in Table 1 above, according to the inks which contained the compound represented by the General formula (1) and in which the amount of the photopolymerizable compound was 70 mass % or more, satellite and mist were less likely to occur (inks 1 to 18). These inks contain the compound represented by the General formula (1), so that the compound is oriented on the surface of a droplet of the inkjet ink to cover the entire droplet. As a result, it is thought that the droplets became less likely to be split, and thus satellites and mist became less likely to be generated. In addition, the printed material obtained from these inks had satisfactory glossiness. It is thought that the shapes of the droplets after landing were likely to become uniform due to the droplet adjusting agent covering the ink droplets.

On the other hand, in a case where the compound represented by General formula (1) was not included, and in particular, the hydrophilic portion was excessively large, the discharge properties from the inkjet nozzle tended to decrease, and satellites and/or mist were generated (ink 19). In this case, the gloss value was also low because the droplet became unstable. Furthermore, in a case where the compound represented by General formula (1) was not included, and a compound having no hydrophilic portion was included, the discharge properties from the inkjet nozzle tended to decrease, and satellites and mist were generated (ink 20).

### INDUSTRIAL APPLICABILITY

According to the present invention, an actinic radiation-curable inkjet ink is provided that is less likely to cause satellites and mist during printing and that can form a coating film having excellent glossiness. The ink is very useful in printing in various industrial fields.

What is claimed is:

1. An actinic radiation-curable inkjet ink, comprising:
a photopolymerizable compound, a photoinitiator, a pigment, and a pigment-dispersing agent, wherein the actinic radiation-curable inkjet ink further comprises a compound represented by General formula (1) below: 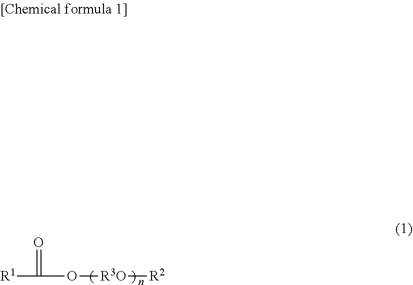
in General formula (1),
R¹ represents a substituted or unsubstituted alkyl group, a substituted or unsubstituted alkenyl group, a substituted or unsubstituted alkoxy group, a substituted or unsubstituted alkylthio group, a substituted or unsubstituted aryl group, a substituted or unsubstituted heterocyclic group, or a combination thereof,
R² represents a hydrogen atom, a substituted or unsubstituted alkyl group, a substituted or unsubstituted alkenyl group, a substituted or unsubstituted alkynyl group, a substituted or unsubstituted aryl group, a substituted or unsubstituted heterocyclic group, or a combination thereof,
R³ represents a substituted or unsubstituted alkylene group having 2 or more and 6 or less carbon atoms, and
n represents an integer of 1 or more and 50 or less, and
an amount of the photopolymerizable compound is 70% by mass or more based on a total mass of the actinic radiation-curable inkjet ink.

2. The actinic radiation-curable inkjet ink according to claim 1, wherein
the compound represented by General formula (1) is a compound represented by General formula (2) below: 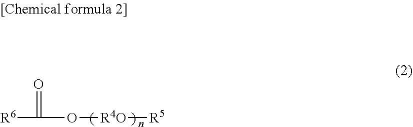
in General formula (2),
R⁴ represents a substituted or unsubstituted ethylene group, a substituted or unsubstituted propylene group, a substituted or unsubstituted trimethylene group, or a substituted or unsubstituted tetramethylene group,
R⁵ represents a hydrogen atom or a substituted or unsubstituted alkyl group having 1 or more and 20 or less carbon atoms,
R⁶ represents an alkyl group having 2 or more and 20 or less carbon atoms or an alkenyl group having 4 or more and 21 or less carbon atoms, and
n represents an integer of 1 or more and 30 or less.

3. The actinic radiation-curable inkjet ink according to claim 1, wherein
the compound represented by General formula (1) is a compound represented by General formula (3) below: 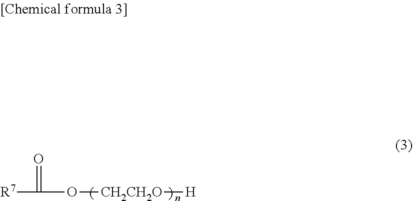
in General formula (3),
R⁷ represents an alkyl group having 15 or more and 19 or less carbon atoms or an alkenyl group having 15 or more and 19 or less carbon atoms, and
n represents an integer of 7 or more and 25 or less.

4. The actinic radiation-curable inkjet ink according to claim 1, further comprising a gelling agent.

5. The actinic radiation-curable inkjet ink according to claim 4, wherein
the gelling agent contains at least one compound of compounds represented by General formulae (G1) and (G2):
R⁵—CO—R⁶ General formula (G1):
R⁷—COO—R⁸ General formula (G2):
in the General formulae (G1) and (G2), R⁵ to R⁸ each independently represent a linear or branched alkyl group having 12 or more and 26 or less carbon atoms.

6. A method for producing a printed material, the method comprising:
discharging an ink droplet of the actinic radiation-curable inkjet ink according to claim 1 from an inkjet recording head to cause the ink droplet to land on a recording medium; and
irradiating the ink droplet having landed on the recording medium with actinic radiation to cure the ink droplet.
